(19) United States
(12) Patent Application Publication
(10) Pub. No.: US 2016/0065494 A1
(43) Pub. Date: Mar. 3, 2016

(54) DATA CLOUD

(71) Applicant: Bull SAS, Les Clayes Sous Bois (FR)

(72) Inventors: Damien AIELLO, LA BUISSE (FR); Renaud DE LASTELLE DU PRE, GRENOBLE (FR); Martin RADANLIEV, GRENOBLE (FR)

(21) Appl. No.: 14/838,725

(22) Filed: Aug. 28, 2015

(30) Foreign Application Priority Data
Aug. 28, 2014 (FR) 14 58085

(51) Int. Cl. H04L 12/911; H04L 29/08

(52) U.S. Cl. CPC H04L 47/783; H04L 67/1097

(57) ABSTRACT

The invention relates to a data cloud comprising-contributor computer stations pooling at least a part of their storages resources in the cloud, and user computer stations storing data on said pooled storage resources so as to share between them the access to said stored data, where a number of said user computer stations are also contributor computer stations.

### PRIORITY CLAIM

The present application claims priority to French Application FR 1458085, filed Aug. 28, 2014, said application being hereby incorporated by reference herein in its entirety.

### FIELD OF THE INVENTION

The invention relates to the field of data clouds, that is to say computer data clouds (“cloud”, or more particularly “cloud storage” or “cloud computing”). These data clouds are used by user computer stations to store data in significant volumes without necessarily having sufficient storage resources of their own to do so.

### BACKGROUND OF THE INVENTION

According to a first prior art, a private data cloud is known in which a single group of duly identified users can use the private data cloud. This private data cloud may be totally managed by an organisation external to the group of users, which presents a number of drawbacks.

First of all, the group of users does not then have any control over the data cloud, and in particular over the stored data pooled in this data cloud.

And then, if there is a need to extend the available storage volume in the data cloud, this extension cannot always be done in a simple and fluid manner, that is to say without notably disrupting the existing operation of the data cloud.

Finally, even if such an extension of the available storage volume in the data cloud is possible in good technical conditions, it is so only with financial conditions that are much more disadvantageous than for the initial storage volume in the data cloud (a little like a telephone fixed price contract which is inexpensive but which, if the contract is exceeded, is billed at a high price).

According to a second prior art, a private data cloud is known in which a single group of duly identified users can use the private data cloud. Even though this private data cloud can be managed partly by the group of users, this data cloud does however present a number of drawbacks.

Firstly, the group of users will often have only limited control over the management of the operation of the data cloud, and even if it had compete control of this management of the operation, it would not always have any genuine control over the storage resources storing the cloud data, the latter being physically located in a hosting system which is distinct from the group of users and over which the group of users does not in fact have any genuine control.

For example, the question may arise of knowing whether there are no leaks of certain data out of the cloud, or else whether there are no copies retained anywhere when a file is deleted, or even whether the cloud is truly closed to the computer stations external to the cloud, or finally whether the redundancy offered is sufficient to ensure satisfactory availability and security?

And then, if there is a need to extend the available storage volume in the data cloud, the hosting system may not be more flexible than the hosting system in the first prior art and the group of users may encounter difficulties comparable to those encountered in a data cloud according to the first prior art, particularly with regard to the pooled storage resources where the group of users, even if it includes the administrators of the data cloud, does not really have any more genuine control than in the data cloud according to the first prior art.

### SUMMARY OF THE INVENTION

The aim of the present invention is to provide a data cloud that at least partially mitigates the above-mentioned drawbacks.

More particularly, the invention aims to provide a data cloud which does not simply give the group of users a more or less extensive level of control over the placement and the management of the data cloud, but which rather gives this group of users genuine control, partial or total depending on whether some or all of the contributor computer stations are also user computer stations, over the physical hosting of the pooled stored data, which is never the case in the first and second known prior arts.

Only this control of the physical costing of the data, partial or total, will completely guarantee the integrity of the pooled stored data to the group of users. Now, this control of the physical hosting of the data is given by the fact that the storage resources aggregated to form the data cloud remain physically on the contributor computer stations which are, for all or some, also user computer stations.

The private data cloud that is thus obtained can in fact be likened to an internal private cloud whose storage resources aggregated to form the data cloud are, wholly or partly, under the direct control of the user stations, that is to say of the group of users. The infrastructure of the data cloud is used by the single group of identified users. The infrastructure of the data cloud is hosted, wholly or partly, by the group of identified users. The infrastructure of the data cloud is managed, wholly or partly, by the group of identified users.

According to embodiments of the invention, the proposed data cloud offers a group of users a solution for a completely controlled and secured pooled data storage space, with simplified shared access.

According to embodiments of the invention, the data cloud offers access to the services by the users on demand and/or access via a broadband network, for example by being directly connected by the internet, and/or a relatively large reserve of pooled storage resources, and/or a reserve of pooled storage resources that can rapidly evolve, and/or a billing to the users per use, advantageously particularly low since the pooled storage resources forming the data cloud are here provided, wholly or partly, by the user computer stations themselves.

According to embodiments of the invention, the data cloud produces a data storage which is object-oriented.

To this end, the present invention proposes a data cloud comprising: contributor computer stations pooling at least a part of their storage resources in the cloud, user computer stations storing data on said pooled storage resources so as to share between them access to said stored data, characterized in that a number of said user computer stations are also contributor computer stations.

The pooled storage resources are functionally aggregated in a pooled storage space, while remaining physically distributed on their original contributor computer stations.

The data stored on the pooled storage resources can be shared, at least in access, advantageously by all the user computer stations of the cloud. All the user computer stations of the cloud can advantageously store pooled data, but are not obliged to do so. Some, preferably most, even more preferentially all, of the computer stations of the cloud are both users and contributors.

To this end, the present invention also proposes a method for using a data cloud comprising an access, to stored data pooled in the cloud, by user computer stations of which at least some are also contributor computer stations, that is to say that they store on their storage resources at least a part of these pooled stored data.

To this end, the present invention also proposes a method for constructing a data cloud comprising: a pooled storage of data, by user computer stations, on storage resources pooled by contributor computer stations, a shared access, to said pooled stored data, by said user computer stations, characterized in that a number of said user computer stations are also contributor computer stations.

According to preferred embodiments, the invention comprises one or more of the following features which can be used separately or in partial combination with one another or in total combination with one another, with one or other of the objects cited previously.

Preferably, all of said user computer stations are also contributor computer stations and/or all of said contributor computer stations are also user computer stations. The fact that all the contributor computer stations are also user computer stations gives total control of the physical hosting of the data to the group of users. The fact that all the user computer stations are also contributor computer stations more uniformly distributes the load of provision of the pooled storage resources.

Preferably, each file of said stored data is stored entirely on the storage resources of at least two different contributor computer stations. Thus, a minimum of redundancy is assured for all the stored files, which offers increased accessibility and which guarantees their restoration in the case of damage or loss on the storage resource of one of the contributor stations.

Preferably, each file of said stored data is stored entirely on the storage resources of a number of different contributor computer stations between 2 and 5. This is a good trade-off between additional volume required for the redundancy and effectiveness of this redundancy.

Preferably, each file of said stored data is stored entirely on the storage resources of a number Nₘᵢₙ of different contributor computer stations of:

$${N}_{min} = \frac{{√}^{3}}{F} ,$$

with U being the total number of user computer stations,

$$F = \frac{Σ Fi}{U} ,$$

Fi being the reliability of each user computer station
of between 0 and 1 which is the percentage of time in which this user computer station is activated, with Nₘᵢₙ rounded to the nearest integer or else to an integer contiguous to this nearest integer, with Nₘᵢₙ being at least 2 or preferably at least 3 whatever the values of U and F. The trade-off obtained between, on the one hand, the effectiveness of the redundancy, and, on the other hand, the additional storage volume required by this redundancy, is thus optimized.

In another alternative option, each file of said stored data is stored entirely on the storage resources of at least a number of a different contributor computer stations, the number of said different contributor computer stations entirely storing a same data file being between the integer less than or equal to the square root of the total number of contributor computer stations and the integer greater than or equal to half the total number of contributor computer stations.

Preferably, the total number of user computer stations is between 5 and 20, and/or the total number of contributor computer stations is between 5 and 20. A community of users of reduced size will find a particular benefit in the use of the data cloud proposed by the invention, in as much as, in the known prior arts, practically no interesting data cloud type is adapted to this size of user community.

The set of user computer stations of a cloud corresponds to a community of users. This community of users may correspond, for example, to a group of members of a same family, to a group of friends, to a small enterprise, or to a work group in a large enterprise. This community of users may also correspond to a large group of users, such as, for example, a large enterprise or even any other type of community, and exceed a hundred or so users, even a thousand or so users, even many more if necessary.

Preferably, the or all the administrator computer station(s) of the cloud is/are also user computer stations. Thus, the group of users retains not only the control of the physical hosting of the stored data pooled in the cloud, but also the control of the management of this cloud. The control of the cloud by the group of users is then maximized.

Preferably, with equal size of storage resources pooled by two contributor computer stations of which one is more often activated than the other, the volume of said data stored on the contributor computer station more often activated is strictly greater than the volume of said data stored on the contributor computer station less often activated. A contributor computer station more often activated is a station more often switched on and therefore more accessible to other user computer stations.

Preferably, with equal size of data volume between two stored data files of which one is more often consulted than the other by the user computer stations, the stored data file more often consulted is entirely stored on as many or more contributor computer stations as/than the stored data file less often consulted, at least some of the stored data files more often consulted being stored on strictly more contributor computer stations than other stored data files less often consulted of similar size. The pooled stored data files the most often consulted are assumed to be the most important and/or the most interesting. An even more robust redundancy is then formed for these files.

Preferably, the contributor computer stations pooling fewer storage resources store, on their pooled storage resources, in relative proportion, more data than the contributor computer stations pooling more storage resources. Thus, the redundancy can be increased, for a same overall additional volume of storage resources used in the data cloud to produce this redundancy. This in fact makes it possible to better distribute the data between contributor computer stations, so that each data file is stored on a number of contributor computer stations, even, if necessary, on many contributor computer stations.

Preferably, the personal data of a user computer station tagged as sensitive personal data are duplicated on pooled storage resources on at least one contributor station different from said user computer station, without becoming accessible to the other user computer stations, not even to the user computer station which would possibly also be the contributor computer station on which said sensitive personal data are duplicated. A backup of server backup type is thus offered to each user station, while maintaining complete confidentiality of these sensitive personal data.

Preferably, this data cloud is a cloud of infrastructure as a service category for the user computer stations. A cloud of infrastructure as a service (IaaS) category is a cloud for which the users do not manage and do not control the underlying infrastructure of the cloud. On the other hand, the users have control over the operating systems, over the storage and over the applications, and, advantageously, over the network capacities, load sharing, firewalls and caches.

Preferably, each user computer station can access the cloud via an internet connection. The accessibility of the data cloud to the users is thus further facilitated.

Preferably, each user computer station hosts a piece of the client part of the cloud, each contributor computer station hosts a piece of the server part of the cloud, each user and contributor computer station hosts a piece of the client part of the cloud and a piece of the server part of the cloud.

Preferably, access to said stored data is strictly prohibited to any computer station which is not identified as user computer station of this cloud or which is not identified as administrator computer station of this cloud. Thus, the security of the data cloud, notably with respect to malicious attacks or even with respect to errors, is further enhanced. As an alternative option, the unidentified computer stations could have very limited access rights, such as, for example, a pure passive consultation without the possibility of electronic copying.

One or more administrator computer stations manage and control the data cloud. This or these administrator computer station(s) obviously have access to the stored data, as administrators. This or these administrator(s) is/are obviously people of trust for the group of users.

Preferably, the management of the data cloud is performed, at least temporarily at the beginning, by one or more administrator computer stations which are not user computer stations. In this way, even a limited and/or beginner group of users can profit from all the advantages relating to a data cloud, without the capital or know-how necessary to set up a data cloud, while retaining complete or partial control over the physical hosting of the pooled stored data.

Instead of giving the group of users more or less control over the management of the data cloud while keeping the control over the physical hosting of the pooled stored data out of reach, as in certain data clouds of the second prior art, total control over the physical hosting of the pooled stored data is given here, while help, more or less extensive, is nevertheless provided in the setting up and the management of the data cloud.

Other features and advantages of the invention will become apparent on reading the following description of a preferred embodiment of the invention, given by way of example and with reference to the attached drawings.

### BRIEF DESCRIPTION OF THE DRAWINGS

FIG. 1 schematically represents an exemplary embodiment of a data cloud according to an embodiment of the invention.

FIG. 2 schematically represents an example of construction and of use of a data cloud according to an embodiment of the invention.

### DETAILED DESCRIPTION OF THE DRAWINGS

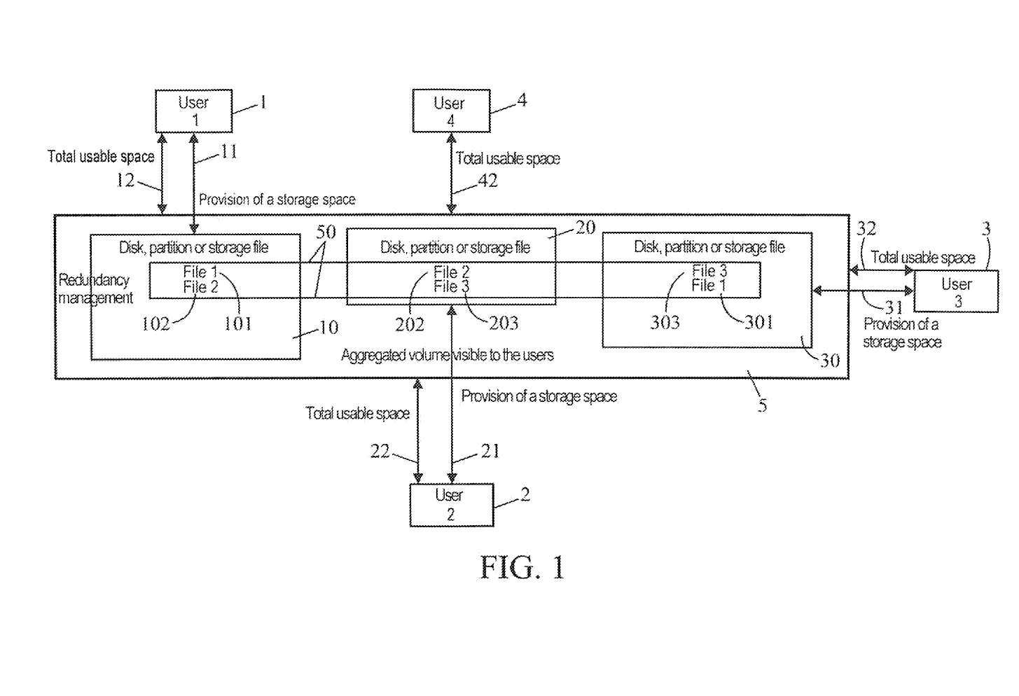

FIG. 1 schematically represents an exemplary embodiment of a data cloud according to an embodiment of the invention. The exemplary data cloud described incorporates only four computer stations for simplicity of description, but, in reality, a data cloud aggregating the storage resources of 5 to 20 computer stations is preferred, and a data cloud aggregating the storage resources of several hundred or even several thousand computer stations can be envisaged. The computer stations can also be called nodes.

Four users have, respectively, four computer stations 1, 2, 3 and 4. The computer stations 1 to 4 are all user computer stations, because they will store data pooled for sharing, that is to say for said data to be able to accessed in a shared manner. Only the computer stations 1 to 3 are contributor computer stations, because only the computer stations 1 to 3 pool a part of their storage resources. The computer station 4 is not a contributor computer station. The computer stations 1 to 3 are user end contributor computer stations, whereas the computer station 4 is only a user computer station.

The user and contributor computer station 1 provides the data cloud functionally with a part of its storage resources that it will retain physically, via an operation of provision 11 of storage resource 10. The user and contributor computer station 1 pools a storage resource 10, for example a storage disk or a partition of a storage disk or a storage file. Similarly, the user and contributor computer station 2 pools a storage resource 20, via an operation of provision 21 of storage resource 20, and the user and contributor computer station 3 pools a storage resource 30, via an operation of provision 31 of storage resource 30.

The pooled storage space that is constituted by the combining of the storage resources 10, 20 and 30 functionally constitutes the set of pooled storage resources of the data cloud 5, the storage resources 10, 20 and 30 remaining physically respectively on the contributor computer stations 1, 2 and 3. This pooled storage space is constituted by the aggregation of the storage resources 10, 20 and 30. However, the management and the control of the storage resources 10, 20 and 30 is beyond the contributor computer stations 1, 2 and 3. The management and the control of the storage resources 10, 20 and 30 is performed by the data cloud 5, and notably by the administrators of the data cloud 5 who are not represented in FIG. 1 for reasons of simplicity.

All the user computer stations, that is to say the computer stations 1 to 4, can store data in this data cloud 5. Assume for example that the user 1 of the computer station 1 wants to store a file 1, that the user 2 of the computer station 2 wants to store a file 2, and that the user 3 of the computer station 3 wants to store a file 3. All the computer stations 1 to 3 will ask the data cloud 5 to respectively store their files 1 to 3.

To increase the availability and the security of the files 1 to 3, the data cloud 5 will not only store them on a storage resource, belonging to a first contributor computer station, but also copy them onto another storage resource, belonging to a second contributor computer station. The data cloud 5 will ensure a certain redundancy in the storage of these files. This redundancy in the storage of the files is put in place to mitigate the drawback associated with the disconnection of one or more contributor computer stations, and a possible corruption of a file in its location in one of the storage resources.

The redundancy is symbolized in FIG. 1 by the zone 50 where it can be seen that the different files are each stored twice. For example, the file 1 is stored on the one hand at the location 101 on the storage resource 10 of the computer station 1 and, on the other hand, at the location 301 on the storage resource 30 of the computation station 3. In this way, if the computer station 1 is inactive, that is to say off, the file 1 is still accessible at the location 301 on the resource 30 of the computer station 3 if the latter is active, that is to say on, and vice versa.

Similarly, for example, the file 2 is stored on the one hand at the location 102 on the storage resource 10 of the computer station 1, and, on the other hand, at the location 202 on the storage resource 20 of the computer station 2, while the file 3 is stored, on the one hand, at the location 203 on the storage resource 20 of the computer station 2 and, on the other hand, at the location 303 on the storage resource 30 of the computer station 3.

This redundancy can be managed finely, notably according to the capacity of each storage resource pooled by each contributor computer station, according to the total number of user computer stations and/or according to statistics of use, by the user computer stations, of the stored data pooled in the data cloud.

Each file of said stored data is stored entirely on the storage resources of a certain number Nₘᵢₙ of different contributor computer stations. This number Nₘᵢₙ is, for example, between 2 and 5.

Preferentially, this number Nₘᵢₙ is:

$${N}_{min} = \frac{{√}^{3} U}{F}$$

rounded to the nearest integer or to an integer immediately adjacent to this nearest integer), with Nₘᵢₙ being at least 2 or else Nₘᵢₙ advantageously being at least 3 regardless of the number of user computer stations and regardless of their reliability, with Nₘᵢₙ which is in fact the number of occurrences of the file, that is to say the number of different places where this file is entirely stored, U which is the total number of user computer stations, F which is the average reliability of the system as a whole, each user computer station having a reliability of between 0 and 1 (0 if the user computer station is never activated, 1 if the user computer station is always activated, 0.5 if the user computer station is activated for half the time, and so on), the average reliability F of the system as a whole is the average of the individual reliabilities Fi of each user computer station i:

$$F = \frac{Σ Fi}{U} .$$

All the user computer stations 1 to 4 can access all of the files 1 to 3, that is to say that all of the storage resources 10, 20 and 30 which have been aggregated within the data cloud 5. This access makes it possible, for example, to read or copy the accessed file. If two user computer stations, for example the computer stations 1 and 4, want to simultaneously access the file 3, the computer station 1 will be able to consult it at the location 203 on the storage resource 20 of the computer station 2, while the computer station 4 will be able to consult it at the location 303 on the storage resource 30 of the computer station 3, provided that the computer stations 2 and 3 are active. As an alternative option, certain user computer stations could be assigned a reduced accessibility, for example to a certain category of files only.

If the copy of the file 1 is damaged at the location 101 on the resource 10 of the computer station 1, it will be able to be restored by using the intact copy of the file 1 stored at the location 301 on the resource 30 of the computer station 3, and vice versa.

The data cloud 5 can evolve. In certain periods, one of the computer stations may have large storage needs and little in the way of storage resources to provide, while another of the computer stations will have little in the way of need for storage and a lot of storage resources to provide, and vice versa in other periods.

For example, at a first moment, the computer station 1 pools a storage resource 10 with a capacity of 100 GB and needs to store only 20 GB of data, whereas the computer station 2 pools a storage resource 20 with a capacity of 20 GB but needs to store 30 GB of data. With the data cloud 5, this is possible, because the latter has 120 GB, and needs to store only 100 GB of data (2 times 50 GB of data to be stored because of the redundancy). In this case, without participation in the data cloud 5, the computer station 2 would not have been able to store all its data, whereas the computer station 1 would have had a lot of storage resource unused.

Conversely, for example at a second moment, the computer station 1 can only pool a storage resource 10 with a capacity of 50 GB but then needs to store 60 GB of data, whereas the computer station 2 can pool a storage resource 20 with a capacity of 150 GB while needing to store only 20 GB of data. With the data cloud 5, it is still possible, because the latter has 200 GB, and needs to store only 160 GB of data (2 times 80 GB of data to be stored because of the redundancy). In this other case, without participation in the data cloud 5, the computer station 1 would not have been able to store all its data, whereas the computer station 2 would have had a lot of storage resource unused.

Apart from the computer stations 1 to 4 belonging to the group of identified users of the data cloud 5, and with the exception of the administrator computer stations of this data cloud 5, nobody can access the stored data pooled in this data cloud 5, apart from a new incoming computer station, duly authorised and identified. The stored data may be texts, photos, videos, presentations, etc.

If the computer station 1 identifies a file as sensitive personal data to be saved, the data cloud 5 can copy it onto the storage resource 10 of the computer station 1 and duplicate it on the storage resource 30 of the computer station 3, without any of the computer stations other than the computer station 1 being able to access it, and not even the computer station 3. The data cloud 5 then offers a backup of “server backup” type to the computer station 1 for its file of sensitive personal data, while maintaining total confidentiality with respect to the other computer stations 2 to 4 which cannot access it and which may even be unaware of its existence. To avoid excessively impacting on the pooled space of data to be shared, such an offering can be limited to a certain quota of storage capacity of confidential backup type for each computer station.

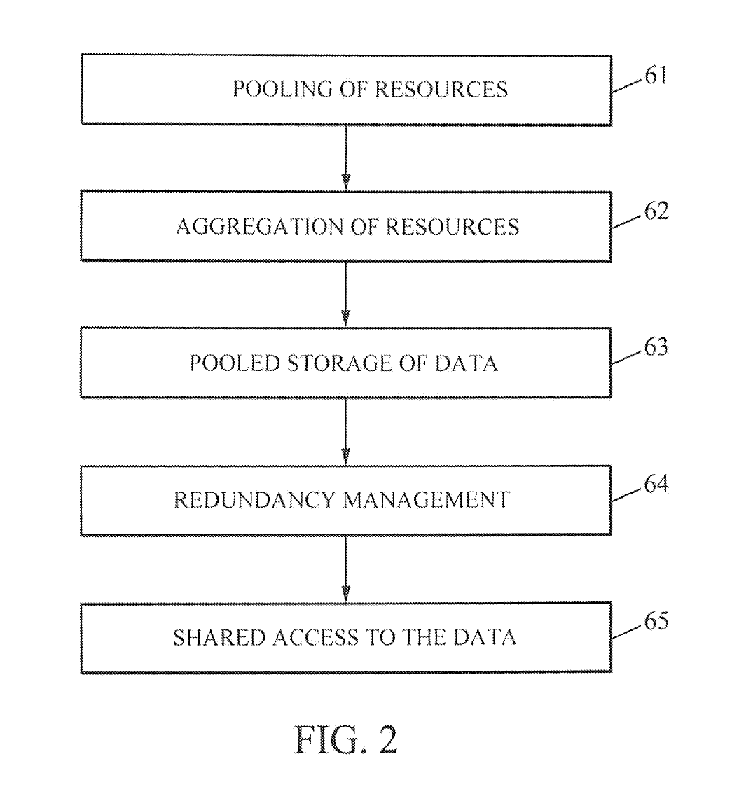

FIG. 2 schematically represents an example of construction and of use of a data cloud according to an embodiment of the invention. A number of construction steps will be carried out in succession then allowing the step of use to progress.

Firstly, in a first construction step, a step of pooling 61 of resources by the different contributor computer stations, each contributor computer station defines either a whole hard disk or several thereof, or a limited partition of a hard disk or several thereof, or even one or more simple storage files, as storage resource pooled, that is to say made available to the data cloud. This storage resource made available constitutes a new node available, either to be added into an existing volume of storage resources, or to participate in the creation of a new volume of storage resources.

Then, in a second construction step, a step of aggregation 62 of all the pooled resources, to functionally constitute a pooled storage space which is physically distributed or spread over the different contributor computer stations.

Then, in a third construction step, a step of pooled storage 63 of data, the different user computer stations request the pooled storage of the data that they want to share between them.

Then, in a fourth construction step, a step of redundancy management 64, performed by the administrators of the data cloud, the data to be stored pooled are stored on a contributor computer station and duplicated at least on one other or several other contributor computer stations, according to different criteria already explained previously. This redundancy ensures, on the one hand, a better availability of the pooled stored data in the event of disconnection of one or more contributor computer stations, and, on the other hand, a better security of the pooled stored data in the event of corruption or loss of data stored on one of the contributor computer stations.

Finally, in a step of use, a step 65 of shared access to the data, all of the user stations can consult and copy all of the stored data pooled in the data cloud. During this step of use, the construction of the data cloud can be continued or modified, that is to say for example that new data can be stored or deleted, new storage resources can be made available or removed by the contributor computer stations, new contributor and/or user computer stations can be added to the data cloud or removed from the data cloud.

Obviously, the present invention is not limited to the examples and the embodiment described and represented, but is open to numerous variants accessible to those skilled in the art.

1. A data cloud comprising:
contributor computer stations pooling at least a part of their storage resources in the cloud, and
user computer stations storing data on said pooled storage resources so as to share between them access to said stored data,
characterized in that a number of said user computer stations are also contributor computer stations.

2. The data cloud according to claim 1, characterized in that all of said user computer stations are also contributor computer stations and all of said contributor computer stations are also user computer stations.

3. The data cloud according to claim 1, characterized in that each file of said stored data is stored entirely on the storage resources of at least two different contributor computer stations.

4. The data cloud according to claim 3, characterized in that each file of said stored data is stored entirely on the storage resources of between 2 and 5 different contributor computer stations.

5. The data cloud according to claim 3, characterized in that:
each file of said stored data is stored entirely on the storage resources of a number Nₘᵢₙ of different contributor computer stations of:
$${N}_{min} = \frac{{√}^{3} U}{F} ,$$
with U being the total number of user computer stations
$$F = \frac{Σ Fi}{U} ,$$
Fi being the reliability of each user computer station of between 0 and 1 which is the percentage of time in which this user computer station is activated,
with Nₘᵢₙ rounded to the nearest integer or else to an integer contiguous to this nearest integer,
with Nₘᵢₙ being at least 2 or preferably at least 3 whatever the values of U and F.

6. The data cloud according to claim 1, characterized in that the total number of user computer stations is between 5 and 20, and the total number of contributor computer stations is between 5 and 20.

7. The data cloud according to claim 1, characterized in that the administrator computer station(s) of the cloud are also user computer stations.

8. The data cloud according to claim 1, characterized in that, with equal size of storage resources pooled by two contributor computer stations of which one is more often activated than the other, the volume of said data stored on the contributor computer station more often activated is strictly greater than the volume of said data stored on the contributor computer station less often activated.

9. The data cloud according to claim 1, characterized in that, with equal size of data volume between two stored data files of which one is more often consulted than the other by the user computer stations, the stored data file more often consulted is entirely stored on as many or more contributor computer stations as/than the stored data file less often consulted, at least some of the stored data files more often consulted being stored on strictly more contributor computer stations than other stored data files less often consulted of similar size.

10. The data cloud according to claim 1, characterized in that the contributor computer stations pooling fewer storage resources store, on their pooled storage resources in relative proportion, more data than the contributor computer stations pooling more storage resources.

11. The data cloud according to claim 1, characterized in that the personal data of a user computer station tagged as sensitive personal data are duplicated on storage resources pooled on at least one contributor station different from said user computer station, without becoming accessible to the other user computer stations, not even to the user computer station which would possibly also be the contributor computer station on which said sensitive personal data are duplicated.

12. The data cloud according to claim 1, characterized in that this data cloud is a cloud of infrastructure as a service category for the user computer stations.

13. The data cloud according to claim 1, characterized in that each user computer station can access the cloud via an internet connection.

14. The data cloud according to claim 1 characterized in that:
each user computer station hosts a piece of the client part of the cloud,
each contributor computer station hosts a piece of the server part of the cloud,
each user and contributor computer station hosts a piece of the client part of the cloud and a piece of the server part of the cloud.

15. The data cloud according to claim 1, characterized in that access to said stored data is strictly prohibited to any computer station which is not identified as user computer station of this cloud or which is not identified as administrator computer station of this cloud.

16. A method for using a data cloud comprising accessing stored data pooled in the cloud, by user computer stations of which at least some are also contributor computer stations, that is to say that they store on their storage resources at least a part of these pooled stored data.

17. A method for constructing a data cloud comprising;
pooling stored data, by user computer stations, on storage resources pooled by contributor computer stations,
accessing the pooled stored data, by said user computer stations,
characterized in that a number of said user computer stations are also contributor computer stations.

18. The method for constructing a data cloud according to claim 17, characterized in that the management of the data cloud is performed, at least temporarily at the beginning, by one or more administrator computer stations which are not user computer stations.
